(19) United States
(12) Patent Application Publication
(10) Pub. No.: US 2026/0043712 A1
(43) Pub. Date: Feb. 12, 2026

(54) MONITORING DEVICE AND MONITORING METHOD

(71) Applicant: NTN Corporation, Osaka (JP)

(72) Inventor: Wataru HATAKEYAMA, Kuwana-shi, Mie (JP)

(21) Appl. No.: 19/099,360

(22) PCT Filed: Aug. 7, 2023
(86) PCT No.: PCT/JP2023/028713

§ 371 Date: Jan. 28, 2025

(30) Foreign Application Priority Data
Aug. 25, 2022 (JP) 2022-134157

(51) Int. Cl. G01M 13/045

(52) U.S. Cl. CPC G01M 13/045

(57) ABSTRACT

A monitoring device includes an acquisition unit that acquires a measured value of a sensor, a detection unit that detects a rubbing noise of a bearing based on the measured value, and a diagnosis unit that diagnoses a state of the bearing based on the measured value, wherein the diagnosis unit diagnoses the bearing using the measured value that does not include the rubbing noise detected by the detection unit.

### TECHNICAL FIELD

The present disclosure relates to a monitoring device and a monitoring method for monitoring a state of a device including a bearing.

### BACKGROUND ART

Conventionally, a monitoring device that monitors a state of a device including a bearing has been known.

Japanese Patent No. 5917956 (PTL 1) describes a monitoring device that calculates an effective value, a peak value, an average value, a crest factor, an effective value after envelope processing, a peak value after envelope processing, and any other value from measured data of sensors provided in various devices using a statistical method and compares the calculated value with its corresponding threshold, thereby determining damage to the bearing.

Japanese Patent No. 5146008 (PTL 2) describes a monitoring device that identifies an abnormal area of a bearing by comparing a frequency spectrum obtained by envelope analysis and frequency analysis with a threshold for each area of the bearing.

Japanese Patent No. 6791770 (PTL 3) discloses a method of reducing, when processing measured data for a rotary machine that is affected by an equipment operating status and noise, false determinations by dividing the entire measured data into a plurality of segments and averaging the machine learning diagnostic results calculated for each segment.

### CITATION LIST

### Patent Literature

PTL 1: Japanese Patent No. 5917956

PTL 2: Japanese Patent No. 5146008

PTL 3: Japanese Patent No. 6791770

### SUMMARY OF INVENTION

### Technical Problem

In bearings used for various devices, an abnormal sound called rubbing noise (squeaking noise) may occur.

A rubbing noise is measured mainly in the frequency band of 1 kHz or higher. The rubbing noise is a rather grating sound for humans, but it is not an abnormal sound caused by damage to the bearing. If the bearing is damaged, however, the amplitude value of vibrations may increase mainly in the frequency band of 1 kHz or higher.

Thus, the method of diagnosing a bearing based on an effective value, a peak value, and the like without taking into account the rubbing noise, as in PTL 1, fails to distinguish between an amplitude value increased by the rubbing noise and an amplitude value increased by bearing damage. As a result, there is a risk of misdiagnosis in the method described in PTL 1.

The rubbing noise often occurs in the cycle of passage of a rolling element over an outer ring of the bearing. The cycle of occurrence of the rubbing noise coincides with the cycle of occurrence of a damage vibration when there is damage to the outer ring of the bearing or the like, such as a dent or delamination. Thus, the method of diagnosing a bearing using envelope analysis as described in PTL 2 fails to distinguish between a spectral peak generated by the rubbing noise and a spectral peak generated by damage to the outer ring of the bearing. As a result, there is a risk of misdiagnosis in the method described in PTL 2. Similarly, there is a risk of misdiagnosis in the method described in PTL 3 due to inclusion of the rubbing noise in the measured data.

The present invention has been made to solve the above-mentioned problems. An object of the present invention is to prevent a decrease in the accuracy of diagnosing a bearing due to the influence of a rubbing noise.

### Solution to Problem

A monitoring device according to an aspect of the present disclosure is a monitoring device that monitors a device including a bearing. The device is equipped with a sensor that measures a physical amount that fluctuates with a vibration of the device. The monitoring device includes an acquisition unit that acquires a measured value of the sensor, a detection unit that detects a rubbing noise of the bearing based on the measured value, and a diagnosis unit that diagnoses a state of the bearing based on the measured value. The diagnosis unit is configured to diagnose the bearing using the measured value that does not include the rubbing noise.

A monitoring device according to another aspect of the present disclosure is a monitoring device that monitors a device including a bearing. The device being equipped with a sensor that measures a physical amount that fluctuates with a vibration of the device. The monitoring device includes an acquisition unit that acquires a measured value of the sensor, a detection unit that detects a rubbing noise of the bearing based on the measured value, and a diagnosis unit that diagnoses a state of the bearing based on the measured value. The diagnosis unit is configured to diagnose the bearing using the measured value that does not include the rubbing noise.

A monitoring method according to an aspect of the present disclosure is a monitoring method of monitoring a state of a device including a bearing. The device is equipped with a sensor that measures a physical amount that fluctuates with a vibration of the device. The monitoring method includes acquiring a measured value of the sensor, detecting a rubbing noise of the bearing based on the measured value, and diagnosing a state of the bearing based on the measured value. The diagnosing includes diagnosing the bearing using the measured value that does not include the rubbing noise.

### Advantageous Effects of Invention

According to the present disclosure, a decrease in the accuracy of diagnosing a bearing due to the influence of the rubbing noise can be prevented.

### BRIEF DESCRIPTION OF DRAWINGS

FIG. 1 schematically shows a configuration of a wind power generation apparatus to which a monitoring device is applied.

FIG. 2 shows an example hardware configuration of the monitoring device.

FIG. 3 is a block diagram showing a functional configuration of the monitoring device.

FIG. 4 is a flowchart showing a procedure of a rubbing noise detection process.

FIG. 5 shows example measured data.

FIG. 6 shows an example frequency spectrum obtained by Fourier transform of the measured data.

FIG. 7 shows example smoothed data obtained by performing a smoothing process on the frequency spectrum.

FIG. 8 shows example segmented data obtained by performing a segmentation process on the smoothed data.

FIG. 9 shows example normalized data obtained by performing a normalization process on the segmented data.

FIG. 10 is a flowchart showing a procedure of a bearing diagnosis process.

FIG. 11 is a diagram for illustrating a method of generating a first estimation model and a second estimation model.

FIG. 12 is a flowchart showing a procedure of a first estimation model generation process.

FIG. 13 is a conceptual diagram for illustrating a method for a rubbing noise detection process according to Modification 1.

FIG. 14 is a flowchart showing a procedure of the rubbing noise detection process according to Modification 1.

FIG. 15 is a flowchart showing a procedure of a bearing diagnosis process according to Modification 2.

FIG. 16 is a flowchart showing a procedure of a bearing diagnosis process according to Modification 3.

FIG. 17 is a diagram for illustrating a method of generating, by a learning device, a second estimation model according to Modification 4.

FIG. 18 is a flowchart showing a procedure of a bearing diagnosis process according to Modification 4.

FIG. 19 is a diagram for illustrating specific examples of configuration variations of the monitoring device.

### DESCRIPTION OF EMBODIMENTS

Embodiments of the present disclosure will be described below in detail with reference to the drawings. In the following drawings, like reference signs refer to like parts and components, and detailed description thereof will not be repeated. The modifications described below may be selectively combined as appropriate.

### Configuration of Wind Power Generation Apparatus

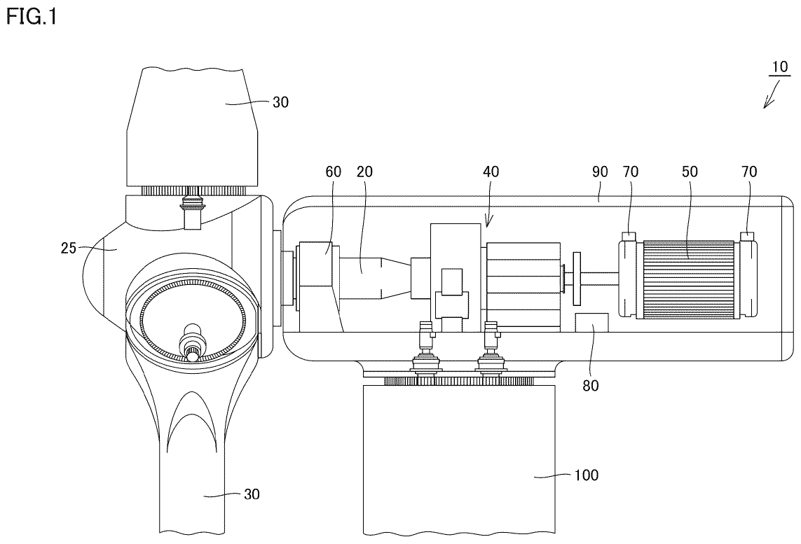

FIG. 1 schematically shows a configuration of a wind power generation apparatus 10 to which a monitoring device 80 according to the present embodiment is applied. Referring to FIG. 1, wind power generation apparatus 10 includes a main shaft 20, a hub 25, a blade 30, a speed-up gear 40, a generator 50, a main shaft bearing 60, a sensor 70, and monitoring device 80. Speed-up gear 40, generator 50, main shaft bearing 60, sensor 70, and monitoring device 80 are housed in a nacelle 90. Nacelle 90 is supported by a tower 100.

Main shaft 20 is connected to the input shaft of speed-up gear 40 and is rotatably supported by main shaft bearing 60. Main shaft 20 transmits a rotational torque generated by blade 30 that has received wind power to the input shaft of speed-up gear 40. Blade 30 is provided on hub 25, converts the wind power into a rotational torque, and transmits the rotational torque to main shaft 20. Main shaft bearing 60 is provided in nacelle 90 and rotatably supports main shaft 20.

Speed-up gear 40 is provided between main shaft 20 and generator 50, and increases the rotation speed of main shaft 20 and outputs it to generator 50. As an example, speed-up gear 40 includes a speed-up gear mechanism including a planetary gear, an intermediate shaft, a high-speed shaft, and the like.

Generator 50 is connected to the output shaft of speed-up gear 40, and generates power by the rotational torque received from speed-up gear 40. Generator 50 includes, for example, an induction generator.

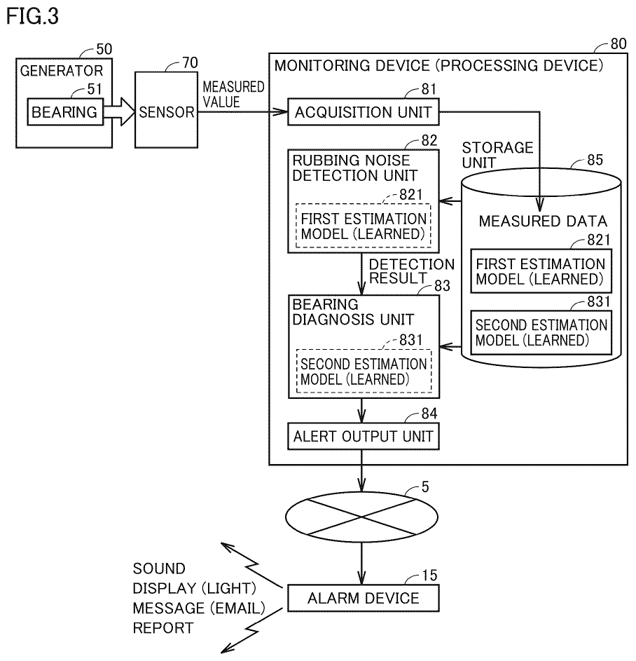

A plurality of bearings 51 (see FIG. 3) are provided in generator 50 that rotatably support the rotor. Generator 50 is an example of the device including a bearing. Each of bearings 51 includes, for example, rolling bearings and has an outer ring (fixed ring), a rolling element, and an inner ring (rotating ring). The rolling bearing may include, for example, a self-aligning roller bearing, a tapered roller bearing, a cylindrical roller bearing, a ball bearing, or any other bearing. The rolling bearing may be configured as a single-row bearing or a double-row bearing.

Generator 50 is equipped with a sensor 70. Sensor 70 measures a vibration of generator 50 and outputs a measured value to monitoring device 80. Since bearing 51 is provided in generator 50, the measured value of sensor 70 includes a vibration element of bearing 51. Examples of the physical amount that fluctuates with a vibration include acceleration, speed, displacement, sound, acoustic emission (AE), and electric power. In the present embodiment, sensor 70 is, for example, a vibration sensor (acceleration pickup) including a piezoelectric element. Sensor 70 may be an acoustic sensor, an AE sensor, or any other sensor.

Monitoring device 80 acquires a measured value from sensor 70. Monitoring device 80 monitors the state of generator 50 based on the acquired measured value. In particular, monitoring device 80 includes a function of diagnosing the presence or absence of an abnormality of bearing 51 based on the acquired measured value. Generally, when a bearing is damaged, the amplitude value of a vibration increases mainly in the frequency band higher than 1 kHz, depending on the type and size of the bearing. Monitoring device 80 can diagnose the presence or absence of an abnormality of bearing 51 using the measured value of sensor 70.

### Relationship between Bearing Damage and Rubbing Noise

The relationship between bearing damage and rubbing noise will now be described. When a plurality of conditions are met, such as gaps, slippage, vibration, and oil film fluctuations inside the bearing, an abnormal noise referred to as rubbing noise (squeaking noise) may occur. The rubbing noise is thought to be caused by friction or collision between the inner and outer rings and the rolling element.

In particular, the occurrence of a rubbing noise is clearly noticeable in generators and electric motors that include bearings. The rubbing noise is a sound that is measured mainly in the frequency band of 1 kHz or higher and is accompanied by a strong vibration (loud high-pitched sound). The rubbing noise is a rather grating sound for humans. However, the rubbing noise is not an abnormal sound caused by damage to the bearing (e.g., wear, delamination, cracking, chipping). In fact, maintenance such as greasing of the bearing may alleviate the rubbing noise.

However, also when the bearing is damaged, the amplitude value of the vibration may increase in the frequency band higher than 1 kHz, as described above. Thus, as described in Japanese Patent No. 5917956 or the like, the method of diagnosing a bearing based on an effective value, a peak value, and any other value without taking into account the rubbing noise fails to distinguish between an amplitude value increased by the rubbing noise and an amplitude value increased by bearing damage.

The rubbing noise often occurs in the cycle of passage of the rolling element over the outer ring of the bearing, and the frequency of such occurrence is the same as the frequency of occurrence of a damage vibration when there is damage to the outer ring of the bearing or the like, such as a dent or delamination. Thus, the method of diagnosing a bearing by envelope analysis, as described in Japanese Patent No. 5146008 or the like, fails to distinguish between a spectrum peak generated by the rubbing noise and a spectrum peak generated by damage to the outer ring of the bearing. Also, measured data cannot be used for bearing diagnosis due to inclusion of an even small amount of rubbing noise into the data.

Therefore, monitoring device 80 according to the present embodiment achieves bearing diagnosis that takes into account a rubbing noise, and prevents a decrease in the accuracy of diagnosing the bearing due to the influence of the rubbing noise, as described below.

Herein, bearing 51 in generator 50 is described as an example of the bearing to be monitored by monitoring device 80. The bearing in speed-up gear 40 and main shaft bearing 60 may be added to the targets to be monitored by monitoring device 80. In addition, the targets to be monitored by monitoring device 80 are not limited to the bearings in wind power generation apparatus 10. For example, the targets to be monitored by monitoring device 80 may be bearings included in various types of devices installed in factories and power plants, as well as bearings included in railway vehicles. In short, monitoring device 80 may be applied to any type of device that includes a bearing supporting a rotating shaft.

### Hardware Configuration of Monitoring Device

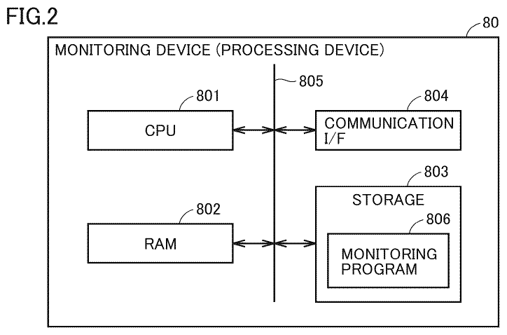

FIG. 2 shows an example hardware configuration of monitoring device 80. Monitoring device 80 includes, for example, a general-purpose computer (processing device) that acquires a measured value of sensor 70 and performs an arithmetic processes.

As shown in FIG. 2, monitoring device 80 includes a central processing unit (CPU) 801, a random access memory (RAM) 802, a storage 803, and a communication interface 804. CPU 801, RAM 802, storage 803, and communication interface 804 are connected via a bus 805.

CPU 801 executes a monitoring program 806 stored in storage 803. RAM 802 provides a work area for storing data necessary for executing monitoring program 806. Storage 803 includes, for example, a hard disk drive (HDD) or a flash solid state drive (SSD). Monitoring program 806 includes programs necessary for CPU 801 to execute the various flowcharts described below.

Communication interface 804 has input/output ports for inputting and outputting various signals. For example, communication interface 804 receives a measured value from sensor 70. Communication interface 804 may output various signals generated by the execution of monitoring program 806 to an external device. The external device is installed outside wind power generation apparatus 10. Communication interface 804 communicates with the external device via a wireless or wired line.

### Functional Configuration of Monitoring Device

FIG. 3 is a block diagram showing a functional configuration of monitoring device 80. As shown in FIG. 3, monitoring device 80 includes an acquisition unit 81, a rubbing noise detection unit 82, a bearing diagnosis unit 83, an alert output unit 84, and a storage unit 85. Storage unit 85 is implemented by, for example, RAM 802 and storage 803 shown in FIG. 2.

Acquisition unit 81, rubbing noise detection unit 82, bearing diagnosis unit 83, and alert output unit 84 are implemented, for example, as CPU 801 shown in FIG. 2 executes monitoring program 806 stored in storage unit 85.

The components such as acquisition unit 81, rubbing noise detection unit 82, bearing diagnosis unit 83, and alert output unit 84 may be implemented by dedicated hardware such as processing circuitry. The above components may be configured such that a plurality of processors and a plurality of memories function in cooperation. The components such as acquisition unit 81, rubbing noise detection unit 82, bearing diagnosis unit 83, and alert output unit 84 may be configured to be implemented by a plurality of independent processing devices. In other words, monitoring device 80 may be composed of a plurality of processing devices that are connected communicatively. In this case, the term “monitoring device” should be understood as a concept that encompasses a monitoring system composed of a plurality of processing devices connected communicatively.

Rubbing noise detection unit 82 detects a rubbing noise generated in bearing 51 using a measured value acquired from sensor 70. In order to detect the rubbing noise, rubbing noise detection unit 82 reads a learned first estimation model 821 from storage unit 85. First estimation model 821 is generated by machine learning using, as feature amount data, the measured data including the rubbing noise.

Bearing diagnosis unit 83 diagnoses abnormalities including damage to bearing 51 using the measured value acquired from sensor 70. Bearing diagnosis unit 83 reads a learned second estimation model 831 from storage unit 85 for diagnosis. Second estimation model 831 is generated by machine learning using, as feature amount data, the measured data including vibration data at the occurrence of a bearing abnormality.

Alert output unit 84 outputs an alert regarding the occurrence of a rubbing noise and an abnormality in bearing 51. Alert output unit 84 is connected to an external alarm device 15 via a network 5 such as the Internet. Alarm device 15 is, for example, a personal computer, a smartphone, or a tablet. Alarm device 15 may be a display device that displays an alarm or a speaker system that outputs an alarm sound. Alert output unit 84 itself may include a function of displaying an alarm or output an alarm sound. Alert output unit 84 may output an alert to an external system such as the cloud.

Acquisition unit 81 acquires a measured value from sensor 70. Each time acquisition unit 81 acquires a measured value from sensor 70, acquisition unit 81 writes, to storage unit 85, data in which a measured value is associated with a time of acquisition of the measured value. As a result, measured data indicating chronological changes in the measured value of sensor 70 is generated and accumulated in storage unit 85.

Rubbing noise detection unit 82 reads the measured data from storage unit 85. Rubbing noise detection unit 82 performs various processes including a Fourier transform process on the measured data that has been read, and then, inputs the acquired data to first estimation model 821. First estimation model 821 outputs an estimation result regarding the presence or absence of a rubbing noise. Rubbing noise detection unit 82 outputs the output of first estimation model 821 as the detection result to bearing diagnosis unit 83.

Bearing diagnosis unit 83 acquires the detection result from rubbing noise detection unit 82. When the detection result acquired from rubbing noise detection unit 82 indicates that there is a rubbing noise, bearing diagnosis unit 83 does not perform bearing diagnosis using the measured data. This can prevent an output of an incorrect bearing diagnosis result from bearing diagnosis unit 83 due to measured data that includes the rubbing noise.

When the detection result acquired from rubbing noise detection unit 82 indicates that there is a rubbing noise, bearing diagnosis unit 83 sets an alert (first alert) for the rubbing noise. Alert output unit 84 outputs the set alert for the rubbing noise to alarm device 15. The worker who maintains wind power generation apparatus 10 can identify the occurrence of a rubbing noise based on the alarm issued by alarm device 15.

When the detection result acquired from rubbing noise detection unit 82 indicates that there is no rubbing noise, bearing diagnosis unit 83 performs bearing diagnosis using the measured data. In this case, bearing diagnosis unit 83 reads the measured data from storage unit 85. Bearing diagnosis unit 83 diagnoses the state of the bearing using the measured data that has been read and second estimation model 831. Bearing diagnosis unit 83 may perform various processes including the Fourier transform process on the measured data, and then, input the acquired data into second estimation model 831.

When the bearing has an abnormality, bearing diagnosis unit 83 sets an alert (second alert) for the bearing abnormality. Alert output unit 84 outputs the set alert for the bearing abnormality to alarm device 15. The worker who maintains wind power generation apparatus 10 can identify that an abnormality has occurred in bearing 51 based on the alarm issued by alarm device 15.

When alarm device 15 includes a personal computer, alert output unit 84 delivers a message (email) or a report notifying of the alert to alarm device 15. Alarm device 15 displays the message or report on a monitor. Alarm device 15 may generate an alarm sound corresponding to the rubbing noise and an alarm sound corresponding to the bearing abnormality from the speaker system, or may turn on a lamp corresponding to the rubbing noise and a lamp corresponding to the bearing abnormality.

In this way, monitoring device 80 accurately detects the rubbing noise and bearing abnormality (bearing damage) and outputs an alert. This allows the worker to efficiently maintain the equipment (wind power generation apparatus 10) that includes bearing 51. As a result, the operating rate of the equipment can be improved. In particular, when the rubbing noise is output as an alert, the worker can also perform additional maintenance to alleviate the rubbing noise. As the worker performs detailed maintenance, the frequency of collection of data that can be used for bearing diagnosis can also be increased.

### Procedure of Rubbing Noise Detection Process

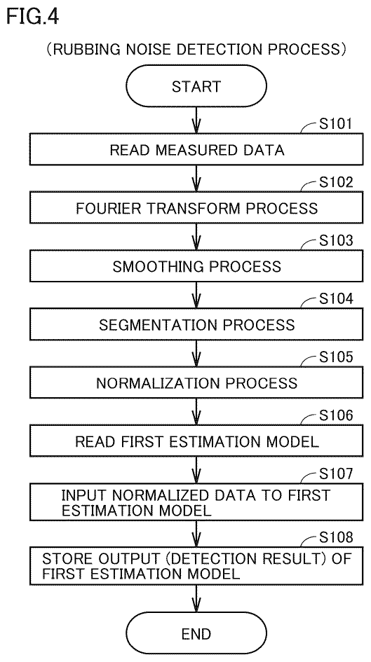

FIG. 4 is a flowchart showing a procedure of a rubbing noise detection process. The rubbing noise detection process is performed by monitoring device 80 (mainly rubbing noise detection unit 82). Monitoring device 80 reads measured data from storage unit 85 (step S101), and then, sequentially performs a Fourier transform process (step S102), a smoothing process (step S103), a segmentation process (step S104), and a normalization process (step S105) on the measured data.

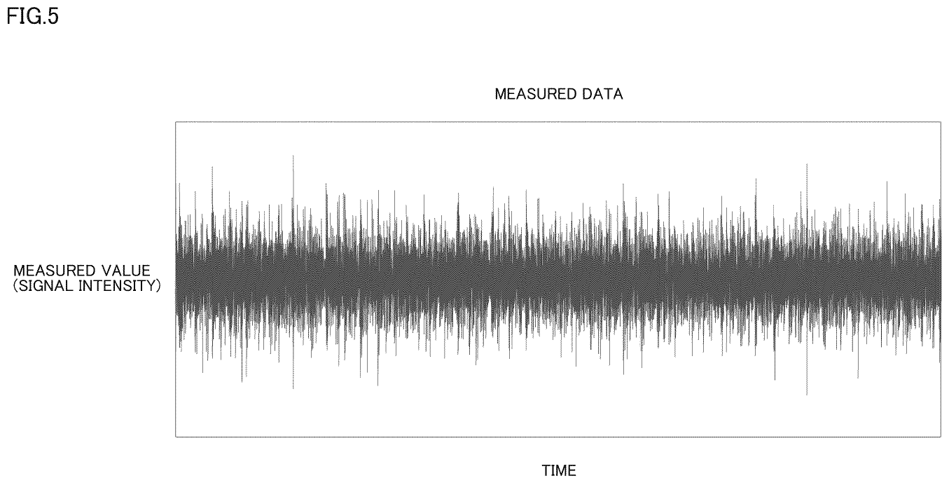

FIGS. 5 to 9 show example waveforms or data related to the respective processes (Steps S101 to S105).

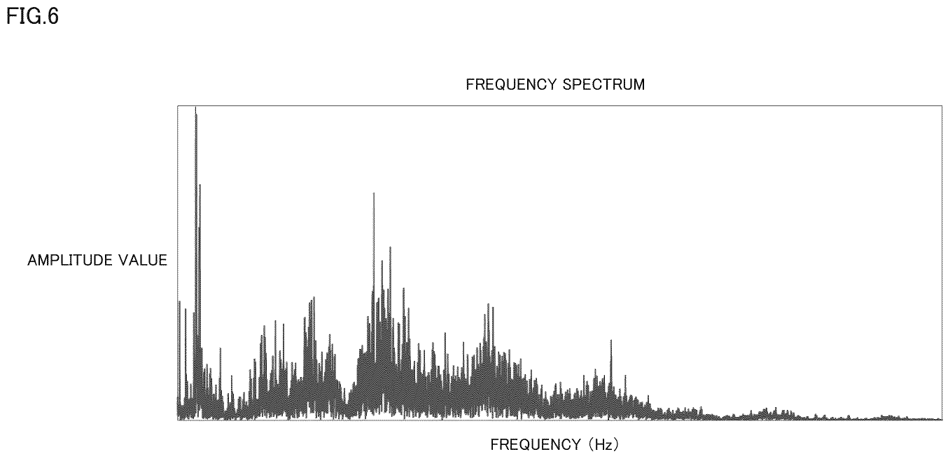

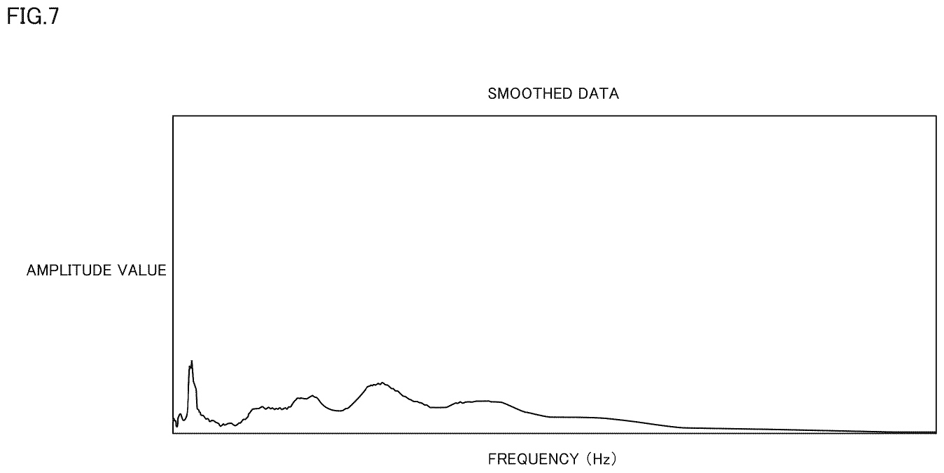

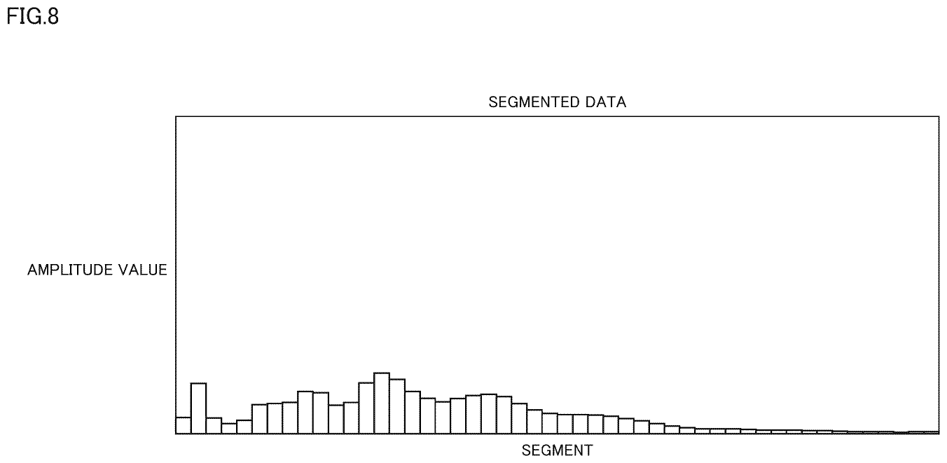

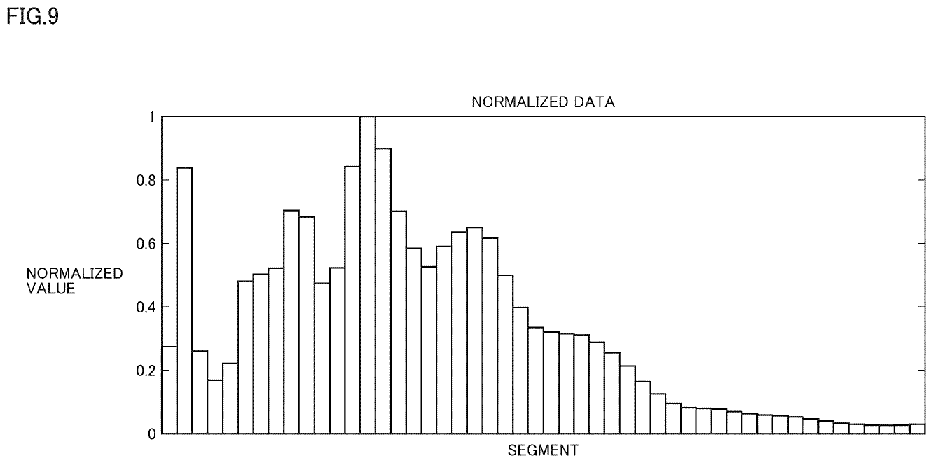

FIG. 5 shows example measured data. The measured data is waveform data showing chronological changes in the measured value of sensor 70. FIG. 6 shows an example frequency spectrum obtained by Fourier transform of the measured data. FIG. 7 shows example smoothed data obtained by performing the smoothing process on the frequency spectrum. FIG. 8 shows example segmented data obtained by performing the segmentation process on the smoothed data. FIG. 9 shows example normalized data obtained by performing the normalization process on the segmented data.

When a rubbing noise occurs, characteristic changes appear in the amplitude values of a plurality of frequency bands of the frequency spectrum obtained by Fourier transform of the measured data. This change is specific to the rubbing noise, regardless of whether or not the bearing is damaged. Such changes specific to the rubbing noise can be found not only when an amplitude value of the frequency spectrum is observed, but also when a power spectral density (PSD) is observed. In the rubbing noise detection process, monitoring device 80 performs various processes including the Fourier transform process on the measured data to detect the presence or absence of a rubbing noise by appropriately capturing the changes specific to the rubbing noise.

Continuing on, the rubbing noise detection process shown in FIG. 4 will be described in detail with reference to FIGS. 5 to 9 as necessary.

### Fourier Transform Process

As shown in FIG. 5, the measured data is time series data showing chronological changes in the measured value of sensor 70. Monitoring device 80 performs the Fourier transform process on the measured data (step S102). In the Fourier transform process, monitoring device 80 generates a frequency spectrum by performing frequency analysis of the measured data. This yields a frequency spectrum (Fourier waveform) as shown in FIG. 6. In the graph of FIG. 6, the horizontal axis indicates frequency (Hz), and the vertical axis indicates amplitude value. The power spectral density (PSD) may be used as the vertical axis. By performing the Fourier transform process, the waveform data of sensor 70 is converted from time domain data into frequency domain data.

### Smoothing Process

Subsequently, monitoring device 80 performs the smoothing process on the frequency spectrum (step S103). In the smoothing process, monitoring device 80 smoothes the frequency spectrum. Herein, it is important to reduce the sensitivity to differences in equipment operating conditions, bearing part numbers, equipment, and the like, without canceling out the changes in the frequency spectrum specific to the rubbing noise. This can improve the robustness against differences in external environmental, such as differences in equipment operating conditions (e.g., rotational speed and load change), bearing part numbers, and equipment, during data collection. For example, when the shaft rotational speed of the equipment changes, a phenomenon in which part of the frequency spectrum band shifts can be seen. The smoothing process is an effective method for reducing the detection sensitivity to such subtle changes.

FIG. 7 shows example smoothed data obtained by performing the smoothing process on the frequency spectrum shown in FIG. 6. In particular, the smoothed data in FIG. 7 is data obtained by performing a running median process on the amplitude values of the frequency spectrum within a certain frequency width. The smoothing method is not limited to the moving median process. For example, any smoothing method that can smooth data to a degree that does not significantly impair the original data shape can be used, such as a moving average process and a smoothing process using local regression.

### Segmentation Process

Subsequently, monitoring device 80 performs the segmentation process on the waveform obtained by the smoothing process (step S104). In the segmentation process, monitoring device 80 divides the frequency band of the frequency spectrum into a plurality of segments, and then, adjusts the amplitude value in each segment to one representative value.

FIG. 8 shows the segmented data obtained by performing the segmentation process on the smoothed data shown in FIG. 7. This segmented data is obtained by dividing the smoothed data shown in FIG. 7 into 50 segments and then setting the average value of the amplitude values of each segment as the amplitude value of the segment in each segment. As the amplitude value of a segment, any value that characterizes the amplitude value within the segment, such as the sum or median of the amplitude values within the segment, may be used, rather than the average value of the amplitude values in the segment.

The purpose of the segmentation process is to reduce a resolution with respect to the frequency spectrum axis. By performing the segmentation process, the sensitivity to differences in equipment operating conditions, bearing part numbers, equipment, and the like can be reduced without canceling out the changes in frequency spectrum specific to a rubbing noise, similarly to the smoothing process.

Therefore, by performing the segmentation process, robustness against differences in external environment can be improved. In particular, by performing the smoothing process and the segmentation process, a data amount can be reduced. In addition, when the measured data is used for machine learning, the number of variables input to the machine learning process is reduced, yielding the effect of an improved processing time.

### Normalization Process

Subsequently, monitoring device 80 performs the normalization process on the waveform obtained by the segmentation process (step S105). This yields normalized data.

The purpose of the normalization process is to cancel out the influence of the magnitude (absolute value) of the amplitude value of the segmented data. For example, in generator 50, the amplitude value of the measured data increases as the load on bearing 51 increases. In this case, the amplitude value of the frequency spectrum obtained from the measured data also increases, and accordingly, the feature amount extracted from the segmented data also increases.

In comparison between the frequency spectrum obtained when the load on bearing 51 is small and the frequency spectrum obtained when the load on bearing 51 is large, though the overall shape characteristics of these frequency spectra are the same, the scale of the amplitude values changes. In this case, there is a risk that the feature amount cannot be evaluated appropriately. This has a negative impact on the accuracy of detecting a rubbing noise. By performing the normalization process, the difference in scale of the amplitude value can be canceled out with the characteristics of the frequency spectrum shape remained. Thus, monitoring device 80 performs the normalization process to render the amplitude value of each segment dimensionless.

FIG. 9 shows example normalized data obtained by performing the normalization process on the segmented data shown in FIG. 8. The normalized data shown in FIG. 9 is obtained by performing the normalization process (scaling) on the segmented data shown in FIG. 8 such that the amplitude values fall within the range from a minimum value 0 to a maximum value 1. As the normalization process, a process of causing the average or median of the amplitude value to be 1 may be used.

As described above, monitoring device 80 performs various processes such as the smoothing process and the segmentation process on the frequency spectrum. If changes specific to a rubbing noise are intended to be evaluated based on an increase or a decrease in single frequency band, it may be difficult to accurately distinguish between the rubbing noise and an increase or a decrease in the frequency band due to differences in equipment operating conditions, bearing part numbers, external noise, and occurrence of bearing damage.

Thus, monitoring device 80 removes noise by smoothing and segmenting the frequency spectrum, and generates data for enabling more accurate detection of a rubbing noise.

Subsequently, monitoring device 80 reads first estimation model 821 from storage unit 85 (step S106).

Subsequently, monitoring device 80 inputs the normalized data to first estimation model 821 (step S107). First estimation model 821 detects a rubbing noise from the normalized data. First estimation model 821 outputs a result indicating the presence or absence of a rubbing noise. Monitoring device 80 stores an output of first estimation model 821 as the detection result (step S108). The stored detection result is used in a bearing diagnosis process described below.

### Procedure of Bearing Diagnosis Process

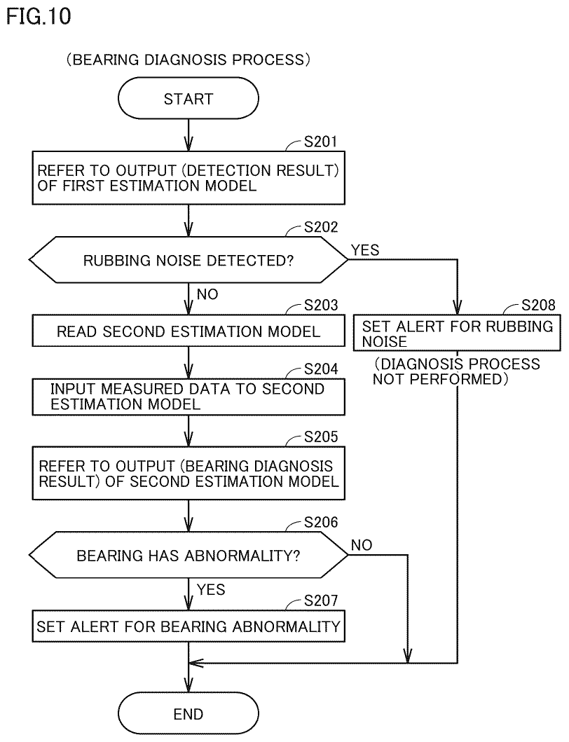

FIG. 10 is a flowchart showing a procedure of the bearing diagnosis process. First, monitoring device 80 refers to the detection result of first estimation model 821 (step S201). Monitoring device 80 then determines whether or not a rubbing noise has been detected (step S202).

When a rubbing noise has been detected, monitoring device 80 sets an alert (first alert) for the rubbing noise (step S208). The set alert for the rubbing noise is output to alarm device 15 by alert output unit 84. When the rubbing noise has been detected, monitoring device 80 completes the shaft diagnosis process without performing a process for diagnosing a bearing abnormality.

When no rubbing noise has been detected, monitoring device 80 reads second estimation model 831 from storage unit 85 (step S203).

Subsequently, monitoring device 80 inputs the measured data to second estimation model 831 (step S204). Second estimation model 831 diagnoses the state of the bearing based on the measured data. Second estimation model 831 outputs a bearing diagnosis result. Monitoring device 80 refers to the output (bearing diagnosis result) of second estimation model 831 (step S205) and determines whether or not the bearing has an abnormality (step S206).

When the bearing has an abnormality, monitoring device 80 sets an alert (second alert) for the bearing abnormality (step S207). The set alert for the rubbing noise is output to alarm device 15 by alert output unit 84. When the bearing has no abnormality, monitoring device 80 completes the bearing diagnosis process.

As described above, monitoring device 80 does not perform bearing diagnosis when a rubbing noise has been detected in the bearing diagnosis process, and performs bearing diagnosis only when no rubbing noise has been detected. In this way, by performing bearing diagnosis while excluding data including a rubbing noise in the measured data, misdiagnosis caused by the rubbing noise can be prevented. As a result, the accuracy of diagnosing a bearing can be improved.

### Generation of Estimation Model

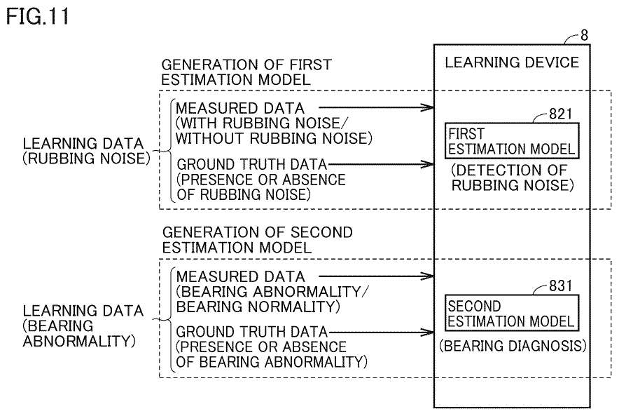

FIG. 11 is a diagram for illustrating a method of generating first estimation model 821 and second estimation model 831. Learning device 8 is, for example, a processing device that has a hardware configuration similar to that of monitoring device 80 shown in FIG. 2. Learning device 8 may be configured of monitoring device 80.

Learning device 8 individually generates first estimation model 821 and second estimation model 831. First estimation model 821 and second estimation model 831 are generated, for example, by supervised machine learning based on an algorithm of any of a decision tree, a random forest, a support vector machine, and a neural network. The learning device that generates first estimation model 821 may be different from the learning device that generates second estimation model 831.

First estimation model 821 is generated for the purpose of estimating the presence or absence of a rubbing noise in the measured data. The learning data for first estimation model 821 includes measured data and ground truth data. Learning device 8 generates learned first estimation model 821 by repeatedly performing machine learning using many pieces of learning data. It is desirable that the learning data include many pieces of measured data that clearly show the characteristics specific to the rubbing noise. Learning device 8 outputs generated first estimation model 821 to monitoring device 80. Monitoring device 80 stores first estimation model 821 in storage unit 85.

Second estimation model 831 is generated for the purpose of estimating the presence or absence of a bearing abnormality from the measured data. The learning data for second estimation model 831 includes measured data and ground truth data. Learning device 8 generates learned second estimation model 831 by repeatedly performing machine learning using many pieces of learning data. It is desirable that the learning data include many pieces of measured data that clearly show the features specific to the bearing abnormality. Learning device 8 outputs generated second estimation model 831 to monitoring device 80. Monitoring device 80 stores second estimation model 831 in storage unit 85.

### Procedure of First Estimation Model Generation Process

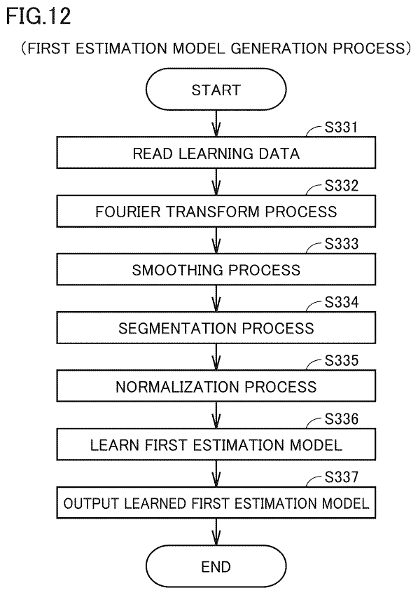

FIG. 12 is a flowchart showing a processing of a first estimation model generation process. Learning device 8 generates first estimation model 821 for detecting a rubbing noise in accordance with the procedure shown in FIG. 12.

The process of generating first estimation model 821 includes the process of reading the learning data shown in FIG. 11 (step S331), the Fourier transform process (step S332), the smoothing process (step S333), the segmentation process (step S334), and the normalization process (step S335).

The details of the Fourier transform process, the smoothing process, the segmentation process, and the normalization process have already been described with reference to FIG. 4, and thus, description thereof will not be repeated. Learning device 8 repeatedly reads learning data and performs the processes (steps S332 to S335) on the measured data, and then, causes first estimation model 821 to learn using the learning data (step S336). Learning device 8 outputs learned first estimation model 821 to monitoring device 80 (step S337). Monitoring device 80 stores first estimation model 821 in storage unit 85.

Herein, the procedure of generating first estimation model 821 has been described, but learning device 8 may generate second estimation model 831 in the same procedure. When generating second estimation model 831, learning device 8 may generate second estimation model 831 using the measured data itself shown in FIG. 5 without performing the processes (steps S332 to S335).

As described above, according to the present embodiment, since a rubbing noise can be detected with high accuracy before bearing diagnosis, the frequency of misdiagnosing bearing damage and rubbing noise can be reduced. As a result, the bearing diagnosis performance can be improved.

Herein, the method of detecting a rubbing noise using first estimation model 821 has been described as an example. However, rubbing noise detection unit 82 may detect a rubbing noise by a method different from the method using first estimation model 821. As already described, when a rubbing noise occurs, characteristic changes appear in the amplitude values of a plurality of frequency bands of a frequency spectrum obtained by Fourier transform of the measured data. This change is specific to the rubbing noise, regardless of whether or not the bearing is damaged.

Therefore, rubbing noise detection unit 82 may detect a rubbing noise by comparing the amplitude values of some specific frequency bands of the frequency spectrum with a predetermined threshold corresponding to each frequency band. However, in order to further improve the detection accuracy, it is desirable to adopt a method of detecting a rubbing noise using first estimation model 821.

Herein, the method of diagnosing a bearing using second estimation model 831 has been described as an example. However, bearing diagnosis unit 83 may diagnose a bearing by a method different from the method using second estimation model 831. For example, as described in Japanese Patent No. 5917956, bearing diagnosis unit 83 may calculate an effective value, a peak value, an average value, a crest factor, an effective value after envelope processing, a peak value after envelope processing, and any other value from the measured data of the sensor using a statistical method, and compare the calculated value with the threshold, thereby detecting a bearing abnormality.

Alternatively, as described in Japanese Patent No. 5146008, bearing diagnosis unit 83 may calculate a frequency spectrum by performing envelope analysis and frequency analysis on a signal obtained from a sensor, and compare the frequency spectrum with a threshold for each area of the bearing, thereby identifying the area of the bearing where the abnormality has occurred.

### Modification 1

In the rubbing noise detection process shown in FIG. 4, an example in which the entire measured data (waveform data) generated is processed collectively has been described. Description will now be given of, as Modification 1, an example in which measured data is divided into a plurality of segments and processing is performed on a segment-by-segment basis.

The rubbing noise does not always occur. The rubbing noise occurs when a plurality of conditions are met, such as gaps, slippage, vibration, and oil film fluctuations inside the bearing. In the measured data that shows the variations in measured value over time, the rubbing noise may occur continuously or may occur only for one or two seconds. Therefore, the waveform data of the part of one piece of measured data which includes no rubbing noise can be used for bearing diagnosis.

Herein, a method is proposed in which a bearing is diagnosed using measured data by dividing one piece of measured data into a plurality of segments and identifying segments that include no rubbing noise. Specifically, segments that include a rubbing noise may be removed, and only segments that include no rubbing noise are used for bearing diagnosis. Alternatively, a method may be used in which the value of a segment that includes a rubbing noise is replaced with a specified value (e.g., zero).

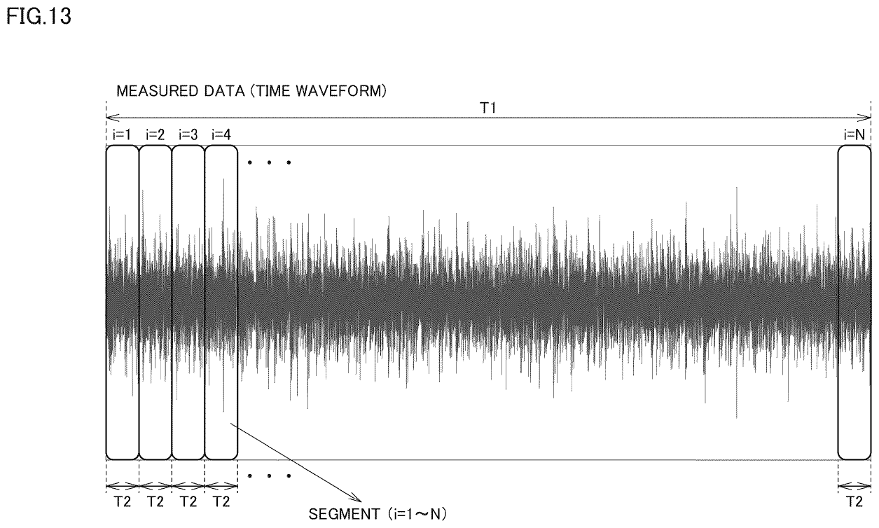

FIG. 13 is a conceptual diagram for illustrating a method for a rubbing noise detection process according to Modification 1. Referring to FIG. 13, the measured data is data for a time length T1 generated based on the measured value of sensor 70. The measured data is stored in storage unit 85.

Rubbing noise detection unit 82 divides the measured data into segments for a time length T2 shorter than time length T1 before performing the Fourier transform process on the measured data. As a result, one piece of measured data is divided into a plurality of (variable i=1 to N) segments. For example, time length T2 may be set to one or two seconds. Monitoring device 80 may be designed such that the user's setting input of time length T2 is accepted. Rubbing noise detection unit 82 detects the rubbing noise for each segment.

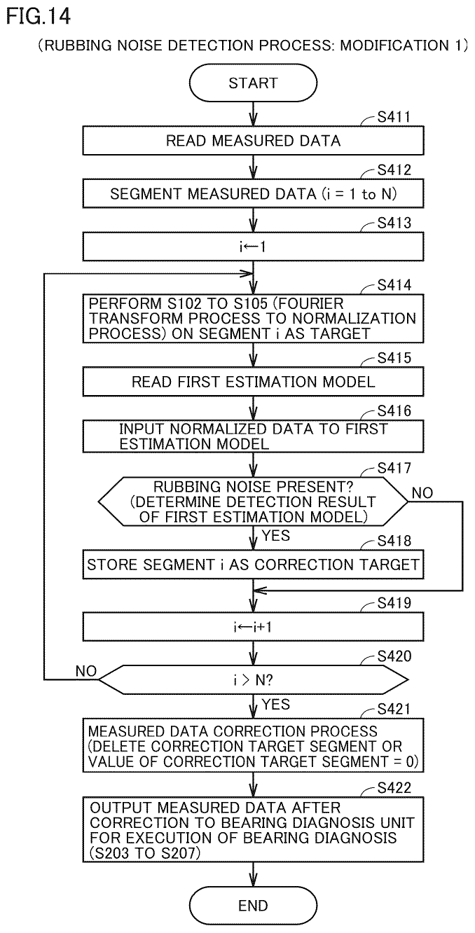

FIG. 14 is a flowchart showing a procedure of the rubbing noise detection process according to Modification 1. Rubbing noise detection unit 82 reads measured data from storage unit 85 (step S411), and then, segments the measured data for segmentation (step S412). Consequently, the measured data is divided into a plurality of (variable i=1 to N) segments (see FIG. 13).

Subsequently, rubbing noise detection unit 82 sets the initial value (=1) to variable i (step S413). Rubbing noise detection unit 82 then performs the Fourier transform process, the smoothing process, the segmentation process, and the normalization process shown in steps S102 to S105 of FIG. 4 on a segment I as a target among segments 1, 2, 3, . . . N (step S414).

Thus, normalized data is generated from the waveform data in units of segments. Subsequently, rubbing noise detection unit 82 reads first estimation model 821 from storage unit 85 (step S415). Rubbing noise detection unit 82 then inputs the normalized data in units of segments to first estimation model 821 (step S416). First estimation model 821 detects a rubbing noise from the normalized data in units of segments. First estimation model 821 outputs a result indicating the presence or absence of a rubbing noise.

Subsequently, rubbing noise detection unit 82 determines whether or not a rubbing noise has been detected in the normalized data in units of segments based on the detection result of first estimation model 821 (step S417). When a rubbing noise has been detected in the normalized data in units of segments, segment i is stored in storage unit 85 as a correction target (step S418). When no rubbing noise has been detected in the normalized data in units of segments, step S418 is not performed. Therefore, the segment that includes no rubbing noise is not to be corrected.

Subsequently, rubbing noise detection unit 82 updates variable i (step S419) and determines whether or not the updated variable i exceeds maximum value N (step S420). Rubbing noise detection unit 82 repeats the processes of steps S414 to S419 unless the updated variable i exceeds N. As a result, a specified value (i) for every segment including the rubbing noise is stored in storage unit 85.

Subsequently, rubbing noise detection unit 82 performs the measured data correction process (step S421). As a result, the value of the part of the measured data corresponding to the segment including the rubbing noise is corrected. Two correction methods are proposed here as the correction method. One method is to provide data including only segments that include no rubbing noise by removing a segment including a rubbing noise. The other method is to replace the value of a segment including a rubbing noise with a specified value (e.g., zero).

Subsequently, rubbing noise detection unit 82 outputs the corrected measured data to bearing diagnosis unit 83, and causes bearing diagnosis unit 83 to perform the bearing diagnosis (steps S203 to S207 in FIG. 10) (step S422). Consequently, rubbing noise detection unit 82 completes the rubbing noise detection process according to Modification 1.

According to Modification 1, even if one piece of measured data partially includes a rubbing noise, the measured data can be used for bearing diagnosis. Therefore, more pieces of measured data can be effectively used for diagnosis. As a result, the frequency of bearing diagnosis can be increased. Increasing the frequency of bearing diagnosis makes it possible to detect bearing damage at an early stage. In addition, when so-called trend analysis is performed, the number of data points increases, making it possible to improve the reliability of the diagnosis.

### Modification 2

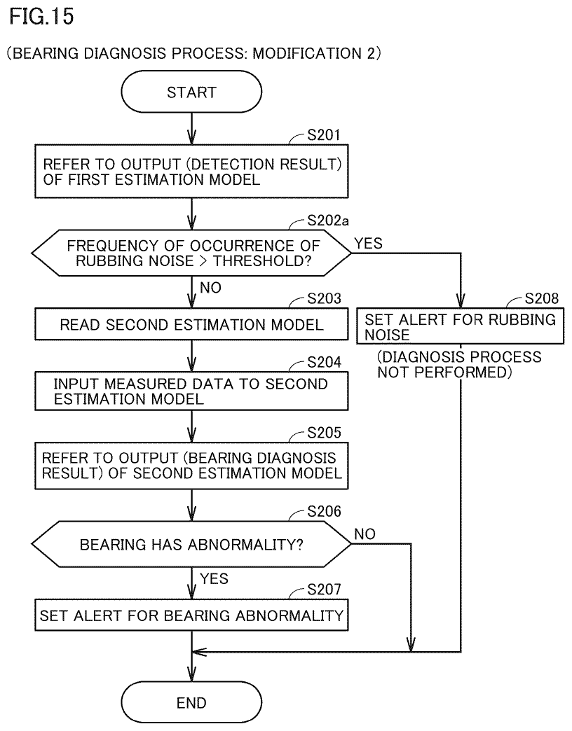

FIG. 15 is a flowchart showing a procedure of a bearing diagnosis process according to Modification 2. When determining the presence or absence of a rubbing noise based on an output of first estimation model 821, monitoring device 80 may use an output of the probability of occurrence (%) of the rubbing noise, rather than using an output of the presence or absence of a rubbing noise (binary classification). In the bearing diagnosis process shown in FIG. 15, a determination step of Step S202a is adopted instead of Step S202, as compared to the bearing diagnosis process shown in FIG. 10. Monitoring device 80 first refers to the output of the rubbing noise output from first estimation model 821 (step S201). In particular, in Modification 2, monitoring device 80 refers to the probability of occurrence of the rubbing noise output from first estimation model 821.

Subsequently, monitoring device 80 compares the probability of occurrence of the rubbing noise with a predetermined threshold (step S202a). When the probability of occurrence of the rubbing noise exceeds the threshold, monitoring device 80 determines that there is a rubbing noise and performs the process of step S208. When the probability of occurrence of the rubbing noise does not exceed the threshold, monitoring device 80 determines that there is no rubbing noise and performs the processes of steps S203 to S207. The threshold can be appropriately set to, for example, 70%. Monitoring device 80 may be designed such that the user's setting input of the threshold cannot be accepted. The details of the processes of steps S203 to S207 have already been described with reference to FIG. 10, and accordingly, description thereof will not be repeated.

According to Modification 2, the presence or absence of a rubbing noise can be determined after evaluating the probability of occurrence output from first estimation model 821 using a threshold.

### Modification 3

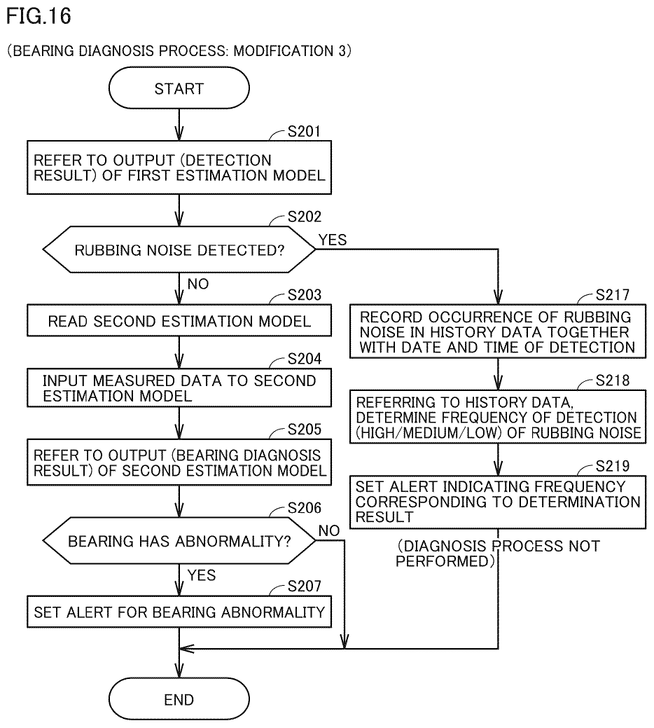

FIG. 16 is a flowchart showing a procedure of a bearing diagnosis process according to Modification 3. An example in which monitoring device 80 outputs the frequency of occurrence of a rubbing noise as an alert to the outside will be described as Modification 3.

In the bearing diagnosis process shown in FIG. 16, the processes of steps S217 to S219 are adopted instead of step S208, compared to the bearing diagnosis process shown in FIG. 10. Step S202, “RUBBING NOISE DETECTED?”, is a branch for evaluating a detection result of the rubbing noise. Thus, when a rubbing noise is detected, monitoring device 80 may refer to the history of past detection results, and if the frequency of detection of a rubbing noise exceeds a predetermined frequency, monitoring device 80 may output an alert indicating that the frequency of occurrence of a rubbing noise is high.

Specifically, monitoring device 80 performs the processes of steps S217 to S219 shown in FIG. 16. When a rubbing noise is detected, monitoring device 80 records the occurrence of the rubbing noise in the history data together with the date and time of the detection (step S217). Monitoring device 80 stores the history data in storage unit 85 and updates the history data each time a rubbing noise is detected.

Subsequently, monitoring device 80 refers to the history data and determines the frequency of detection of the rubbing noise (high/medium/low) (step S218). Monitoring device 80 uses a first threshold and a second threshold (first threshold>second threshold) to determine “high”, “medium”, and “low” of the frequency of detection. Monitoring device 80 determines that “frequency of detection =high” when the frequency of detection exceeds the first threshold, determines that “frequency of detection=low” when the frequency of detection is less than or equal to the second threshold, and determines that “frequency of detection=medium” when the frequency of detection is other than those. The first threshold and the second threshold can be set as appropriate. Monitoring device 80 may be designed such that the user's setting input of the first threshold and the second threshold can be accepted.

Subsequently, monitoring device 80 sets an alert (third alert) indicating the frequency corresponding to the determination result (step S219). In addition to the alert indicating the frequency corresponding to the determination result, monitoring device 80 may set an alert for the rubbing noise (see step S208 in FIG. 10). The set alert is output to alarm device 15 by alert output unit 84.

According to Modification 3, the worker who maintains wind power generation apparatus 10 can identify the frequency of occurrence of the rubbing noise based on an alarm issued by alarm device 15.

### Modification 4

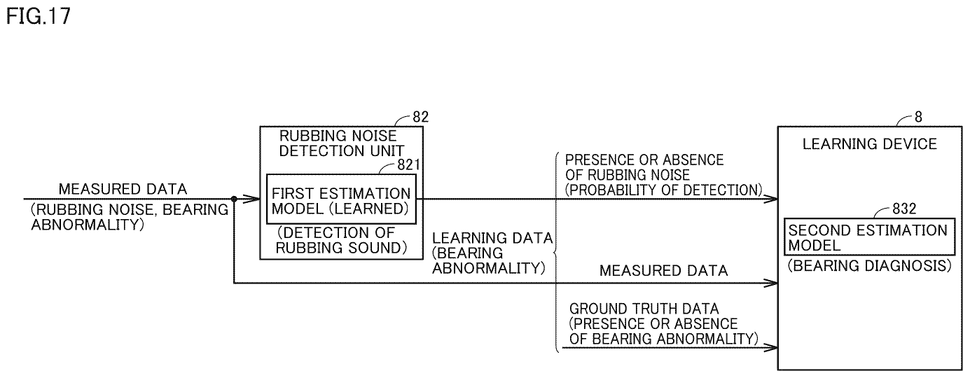

FIG. 17 is a diagram for illustrating a method of generating, by learning device 8, a second estimation model 832 according to Modification 4. Herein, a method is proposed in which second estimation model 832 is generated using not only the measured data but also the output of learned first estimation model 821 as the feature amount.

As shown in FIG. 17, rubbing noise detection unit 82 has read learned first estimation model 821, and learning device 8 has read second estimation model 832 that is a target for machine learning. Rubbing noise detection unit 82 and learning device 8 receive inputs of many pieces of measured data in synchronization. The many pieces of data include measured data acquired at the occurrence of a rubbing noise, measured data acquired at the occurrence of a bearing abnormality, and measured data acquired at simultaneous occurrence of a rubbing noise and a bearing abnormality.

As shown in FIG. 17, the learning data for second estimation model 832 is composed of the output of learned first estimation model 821, the measured data, and the ground truth data (presence or absence of bearing abnormality) for the measured data.

When receiving the measured data, rubbing noise detection unit 82 uses first estimation model 821 to detect a rubbing noise. First estimation model 821 outputs a detection result to learning device 8 as one piece of learning data for second estimation model 832. The detection result of first estimation model 821 may be information merely indicating the presence or absence (binary classification) of a rubbing noise, or the probability of occurrence (%) of a rubbing noise. In addition to the detection result of first estimation model 821, measured data and ground truth data are input to learning device 8. The measured data input here is the same as the measured data that is a target for first estimation model 821 to calculate a detection result.

Learning device 8 generates learned second estimation model 832 by repeatedly performing machine learning using many pieces of learning data. In this way, second estimation model 832 is generated by machine learning based on the measured data and the output value of learned first estimation model 821. Learned second estimation model 832 is stored in storage unit 85 of monitoring device 80.

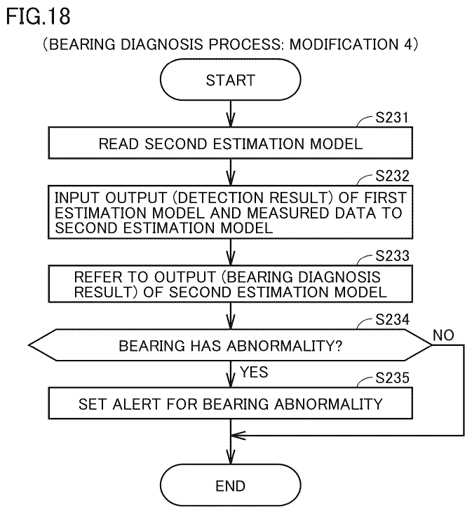

FIG. 18 is a flowchart showing a procedure of the bearing diagnosis process according to Example 4. In the bearing diagnosis process according to Example 4, learned second estimation model 832 described with reference to FIG. 17 is used. In the bearing diagnosis process shown in FIG. 18, monitoring device 80 reads second estimation model 832 from storage unit 85 (step S231).

Subsequently, monitoring device 80 inputs the output (detection result) of first estimation model 821 and the measured data to second estimation model 832 (step S232). The measured data input to second estimation model 832 is the same as the measured data input to learned first estimation model 821 via rubbing noise detection unit 82.

Second estimation model 832 diagnoses the state of the bearing based on the measured data and the output of first estimation model 821. Second estimation model 832 outputs a diagnosis result of the bearing. The processes of steps S233 to S235 are the same as the processes of steps S205 to S207 described with reference to FIG. 10. Thus, description of those processes will not be repeated.

Second estimation model 832 according to Modification 4 is generated using not only the measured data but also the learning data including information on the presence or absence of a rubbing noise. As a result, for example, the diagnosis accuracy of monitoring device 80 when performing bearing diagnosis based on measured data acquired at the simultaneous occurrence of a rubbing noise and bearing damage can be improved.

### Configuration Variations of Monitoring Device 80

Configuration variations of monitoring device 80 will now be described. As shown in FIG. 1, monitoring device 80 may be arranged in wind power generation apparatus 10 that includes bearing 51 to be monitored. Alternatively, monitoring device 80 may be configured to be connected to wind power generation apparatus 10 via a network such as the Internet. In this case, monitoring device 80 is configured to receive a measured value of sensor 70 in wind power generation apparatus 10 which is transmitted via the network.

As shown in FIG. 2, monitoring device 80 may be configured of a general-purpose computer (processing device). In this case, the components for implementing monitoring device 80, such as acquisition unit 81, rubbing noise detection unit 82, bearing diagnosis unit 83, and alert output unit 84, are implemented by a single processing device.

Alternatively, monitoring device 80 may be configured of the components distributed among a plurality of processing devices. In this case, monitoring device 80 is implemented by a collection of a plurality of processing devices. When monitoring device 80 is implemented by a collection of a plurality of processing devices, such a monitoring device 80 may be referred to as a monitoring system. The monitoring system may include a first processing device 80A and a second processing device 80B, and may be referred to as a monitoring system with sensor 70 included.

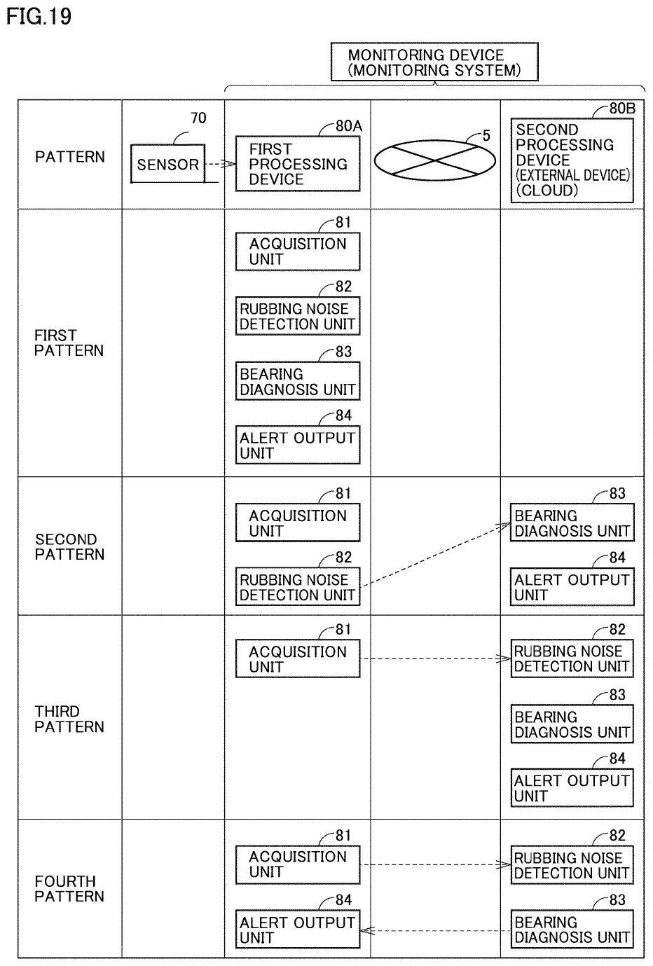

FIG. 19 is a diagram for illustrating specific examples of configuration variations of monitoring device 80. FIG. 19 shows a first pattern in which monitoring device 80 includes first processing device 80A, and second to fourth patterns in which monitoring device 80 includes first processing device 80A and second processing device 80B. Second processing device 80B is an external device that is communicatively connected to first processing device 80A via network 5 such as the Internet. Second processing device 80B may include a cloud server. Note that the configuration variations of monitoring device 80 are not limited to those shown in FIG. 19.

The first pattern is an example in which acquisition unit 81, rubbing noise detection unit 82, bearing diagnosis unit 83, and alert output unit 84 are provided in first processing device 80A. The first pattern corresponds to the configuration shown in FIGS. 2 and 3.

The second pattern is an example in which acquisition unit 81 and rubbing noise detection unit 82 are provided in first processing device 80A, and bearing diagnosis unit 83 and alert output unit 84 are provided in second processing device 80B. In the second pattern, rubbing noise detection unit 82 transmits a detection result to bearing diagnosis unit 83 via network 5.

The third pattern is an example in which acquisition unit 81 is provided in first processing device 80A, and rubbing noise detection unit 82, bearing diagnosis unit 83, and alert output unit 84 are provided in second processing device 80B. In the third pattern, acquisition unit 81 transmits a measured value to rubbing noise detection unit 82 via network 5.

The fourth pattern is an example in which acquisition unit 81 and alert output unit 84 are provided in first processing device 80A, and rubbing noise detection unit 82 and bearing diagnosis unit 83 are provided in second processing device 80B. In the third pattern, acquisition unit 81 transmits a measured value to rubbing noise detection unit 82 via network 5, and bearing diagnosis unit 83 transmits a diagnosis result to alert output unit 84 via network 5.

Thus, in the present embodiment, a configuration in which some of a plurality of arithmetic processes necessary for monitoring a bearing are performed by second processing device or performed by a plurality of processing devices in a distributed manner is also assumed in addition to a configuration (edge computing) in which these arithmetic processes are performed by a single first processing device 80A. Second processing device 80B may be configured of an external terminal such as a personal computer, a smartphone, or a tablet. Second processing device 80B may be configured of a so-called cloud.

### Other Modifications

Monitoring device 80 according to the present embodiment performs the Fourier transform process, the smoothing process, the segmentation process, and the normalization process in order. However, the present embodiment does not preclude the addition of any other as-needed process between the processes. For example, some process for more finely removing noise or some supplementary process may be added before or after any of these processes.

Monitoring device 80 according to the present embodiment detects a rubbing noise using the normalized data obtained by the normalization process. This enables the rubbing noise to be detected with greater accuracy. However, the present embodiment does not preclude a manner in which a rubbing noise is detected using segmented data or smoothed data instead of the normalized data.

Furthermore, the present embodiment does not preclude a manner in which a rubbing noise is detected using a frequency spectrum before the smoothing process, instead of the normalized data. The present embodiment has one feature in that, before bearing diagnosis, a process of detecting a rubbing noise is performed separately from the bearing diagnosis process, and bearing diagnosis is performed based on data from which the influence of the rubbing noise has been removed.

Machine learning of second estimation model 831 may be performed using the measured data itself that has not been subjected to the Fourier transform process, or machine learning of second estimation model 831 may be performed using the frequency spectrum after the Fourier transform process. As in the case of performing machine learning of first estimation model 821, machine learning of second estimation model 831 may be performed using normalized data. The data in the format used during machine learning is input to learned second estimation model 831.

Monitoring device 80 may perform rubbing noise detection and bearing diagnosis on a plurality of types of bearings provided in wind power generation apparatus 10.

### [Aspects]

The following is a list of the items of the present disclosure.

(Item 1) A monitoring device according to item 1 is a monitoring device that monitors a state of a device including a bearing. The device is equipped with a sensor that measures a physical amount that fluctuates with a vibration of the device. The monitoring device includes an acquisition unit that acquires a measured value of the sensor, a detection unit that detects a rubbing noise of the bearing based on the measured value, and a diagnosis unit that diagnoses a state of the bearing based on the measured value. The diagnosis unit is configured to diagnose the bearing using the measured value that does not include the rubbing noise.

(Item 2) In the monitoring device according to item 1, the diagnosis unit is configured to specify the measured value that does not include the rubbing noise detected by the detection unit by determining the measured value in which the rubbing noise has been detected by the detection unit.

(Item 3) In the monitoring device according to item 1, the detection unit is configured to divide measured data into a plurality of pieces of segment data in a time axis direction and detect the rubbing noise for each segment data, the measured data indicating a temporal change in the measured value of the sensor. The detection unit is configured to correct a segment data portion of the measured data in which the rubbing noise has been detected. The diagnosis unit diagnoses the bearing using the corrected measured data, the corrected measured data corresponding to the measured value that does not include the rubbing noise detected by the detection unit.

(Item 4) In the monitoring device according to item 3, the correction is to delete from the measured data, the segment data portion including the rubbing noise.

(Item 5) In the monitoring device according to item 3, the correction is to change the measured value of the segment data portion including the rubbing noise to a specified value.

(Item 6) In the monitoring device according to any one of items 1 to 3, the detection unit is configured to perform processes including a Fourier transform process, a smoothing process, a segmentation process, and a normalization process in order on the measured data indicating a temporal change in the measured value of the sensor. The detection unit is configured to input, to a first estimation model for detecting the rubbing noise, normalized data generated by performing the processes in order, to detect the rubbing noise.

(Item 7) In the monitoring device according to item 6, the detection unit is configured to divide the measured data indicating the temporal change in the measured value of the sensor into a plurality of pieces of segment data in a time axis direction and input normalized data in units of segments to the first estimation model to detect the rubbing noise, the normalized data in units of segments being generated by performing the processes in order on the plurality of pieces of segment data (Item 8) In the monitoring device according to item 6 or 7, the first estimation model is generated by machine learning based on an algorithm of any of a decision tree, a random forest, a support vector machine, and a neural network, using the measured data including the rubbing sound as feature amount data.

(Item 9) In the monitoring device according to any one of items 6 to 8, the detection unit is configured to output, as a detection result of the rubbing noise, presence or absence of the rubbing noise or a probability of occurrence of the rubbing noise.

(Item 10) In the monitoring device according to any one of items 1 to 9, the sensor is any of a vibration sensor, an acoustic sensor, and an AE sensor.

(Item 11) In the monitoring device according to any one of items 1 to 10, the monitoring device includes a first processing device and a second processing device. The first processing device includes the acquisition unit. The second processing device includes at least one of the detection unit and the diagnosis unit.

(Item 12) In the monitoring device according to item 11, the first processing device and the second processing device are communicatively connected via a network.

(Item 13) The monitoring device according to any one of items 1 to 12 further includes an output unit that outputs an alert. The output unit is configured to output a first alert when the rubbing noise is detected by the detection unit.

(Item 14) In the monitoring device according to item 13, the output unit is configured to output a second alert when an abnormality of the bearing is diagnosed by the diagnosis unit.

(Item 15) In the monitoring device according to item 13 or 14, the output unit is configured to output a third alert when a frequency of detection of the rubbing noise exceeds a threshold.

(Item 16) In the monitoring device according to any one of items 13 to 15, the alert includes a format of at least any one of an electrical signal, a message, and a data file.

(Item 17) A monitoring device according to item 17 is a monitoring device that monitors a state of a device including a bearing. The device is equipped with a sensor that measures a physical amount that fluctuates with a vibration of the device. The monitoring device includes an acquisition unit that acquires a measured value of the sensor, a detection unit that detects a rubbing noise of the bearing based on the measured value, and a diagnosis unit that diagnoses a state of the bearing based on the measured value. The detection unit is configured to input data generated based on the measured data to a first estimation model for detecting the rubbing noise to detect the rubbing noise. The diagnosis unit is configured to input a detection result of the detection unit and data generated based on the measured value to a second estimation model for diagnosing the bearing to diagnose the bearing.

(Item 18) In the monitoring device according to item 17, the second estimation model is generated by machine learning so as to diagnose the bearing based on the detection result of the detection unit and the data.

(Item 19) A monitoring method according to item 19 is a monitoring method of monitoring a state of a device including a bearing. The device is equipped with a sensor that measures a physical amount that fluctuates with a vibration of the device. The monitoring method includes acquiring a measured value of the sensor, detecting a rubbing noise of the bearing based on the measured value, and diagnosing a state of the bearing based on the measured value. The diagnosing includes diagnosing the bearing using the measured value that does not include the rubbing noise.

It should be understood that the embodiments disclosed herein are illustrative and non-restrictive in every respect. The scope of the present disclosure is defined by the scope of the claims, rather than the description on the embodiments above, and is intended to include any modifications within the meaning and scope equivalent to the scope of the claims.

### REFERENCE SIGNS LIST

1 monitoring device; 5 network; 8 learning device; 10 wind power generation apparatus; 15 alarm device; 20 main shaft; 25 hub; 30 blade; 40 speed-up gear; 50 generator; 60 main shaft bearing; 70 sensor; 80 monitoring device (processing device); 80A first processing device; 80B second processing device; 81 acquisition unit; 82 rubbing noise detection unit; 83 bearing diagnosis unit; 84 alert output unit; 85 storage unit; 90 nacelle; 100 tower; 401 bearing; 801 CPU; 802 RAM; 803 storage; 804 communication interface; 805 bus; 806 monitoring program; 821 first estimation model; 831, 832 second estimation model.

1. A monitoring device that monitors a state of a device including a bearing,
the device being equipped with a sensor that measures a physical amount that fluctuates with a vibration of the device,
the monitoring device comprising:
an acquisition unit that acquires a measured value of the sensor;
a detection unit that detects a rubbing noise of the bearing based on the measured value; and
a diagnosis unit that diagnoses a state of the bearing based on the measured value,
wherein the diagnosis unit is configured to diagnose the bearing using the measured value that does not include the rubbing noise.

2. The monitoring device according to claim 1, wherein the diagnosis unit is configured to specify the measured value that does not include the rubbing noise detected by the detection unit by determining the measured value in which the rubbing noise has been detected by the detection unit.

3. The monitoring device according to claim 1, wherein
the detection unit is configured to divide measured data into a plurality of pieces of segment data in a time axis direction and detect the rubbing noise for each segment data, the measured data indicating a temporal change in the measured value of the sensor,
the detection unit is configured to correct a segment data portion of the measured data in which the rubbing noise has been detected, and
the diagnosis unit is configured to diagnose the bearing using the corrected measured data, the corrected measured data corresponding to the measured value that does not include the rubbing noise detected by the detection unit.

4. The monitoring device according to claim 3, wherein the correction is to delete, from the measured data, the segment data portion including the rubbing noise.

5. The monitoring device according to claim 3, wherein the correction is to change the measured value of the segment data portion including the rubbing noise to a specified value.

6. The monitoring device according to claim 1, wherein
the detection unit is configured to perform processes including a Fourier transform process, a smoothing process, a segmentation process, and a normalization process in order on the measured data indicating a temporal change in the measured value of the sensor, and
the detection unit is configured to input, to a first estimation model for detecting the rubbing noise, normalized data generated by performing the processes in order, to detect the rubbing noise.

7. The monitoring device according to claim 6, wherein the detection unit is configured to divide the measured data indicating the temporal change in the measured value of the sensor into a plurality of pieces of segment data in a time axis direction and input normalized data in units of segments to the first estimation model to detect the rubbing noise, the normalized data in units of segments being generated by performing the processes in order on the plurality of pieces of segment data.

8. The monitoring device according to claim 6, wherein the first estimation model is generated by machine learning based on an algorithm of any of a decision tree, a random forest, a support vector machine, and a neural network, using the measured data including the rubbing sound as feature amount data.

9. The monitoring device according to claim 6, wherein the detection unit is configured to output, as a detection result of the rubbing noise, presence or absence of the rubbing noise or a probability of occurrence of the rubbing noise.

10. The monitoring device according to claim 1, wherein the sensor is any of a vibration sensor, an acoustic sensor, and an acoustic emission (AE) sensor.

11. The monitoring device according to claim 1, wherein
the monitoring device includes a first processing device and a second processing device,
the first processing device includes the acquisition unit, and
the second processing device includes at least one of the detection unit and the diagnosis unit.

12. The monitoring device according to claim 11, wherein the first processing device and the second processing device are communicatively connected via a network.

13. The monitoring device according to claim 1, further comprising an output unit that outputs an alert,
wherein the output unit is configured to output a first alert when the rubbing noise is detected by the detection unit.

14. The monitoring device according to claim 13, wherein the output unit is configured to output a second alert when an abnormality of the bearing is diagnosed by the diagnosis unit.

15. The monitoring device according to claim 13, wherein the output unit is configured to output a third alert when a frequency of detection of the rubbing noise exceeds a threshold.

16. The monitoring device according to claim 13, wherein the alert includes a format of at least any one of an electrical signal, a message, and a data file.

17. A monitoring device that monitors a state of a device including a bearing,
the device being equipped with a sensor that measures a physical amount that fluctuates with a vibration of the device,
the monitoring device comprising:
an acquisition unit that acquires a measured value of the sensor;
a detection unit that detects a rubbing noise of the bearing based on the measured value; and
a diagnosis unit that diagnoses a state of the bearing based on the measured value, wherein
the detection unit is configured to input data generated based on the measured value to a first estimation model for detecting the rubbing noise to detect the rubbing noise, and
the diagnosis unit is configured to input a detection result of the detection unit and data generated based on the measured value to a second estimation model for diagnosing the bearing to diagnose the bearing.

18. The monitoring device according to claim 17, wherein the second estimation model is generated by machine learning so as to diagnose the bearing based on the detection result of the detection unit and the data generated based on the measured value.

19. A monitoring method of monitoring a state of a device including a bearing,
the device being equipped with a sensor that measures a physical amount that fluctuates with a vibration of the device,
the method comprising:
acquiring a measured value of the sensor;
detecting a rubbing noise of the bearing based on the measured value; and
diagnosing a state of the bearing based on the measured value,
wherein the diagnosing includes diagnosing the bearing using the measured value that does not include the rubbing noise.
